(19) United States
(12) Patent Application Publication
(10) Pub. No.: US 2021/0325253 A1
(43) Pub. Date: Oct. 21, 2021

(54) OPTICAL SENSING METHOD AND OPTICAL SENSOR MODULE THEREOF

(71) Applicant: SENSORTEK TECHNOLOGY CORP., ZHUBEI CITY (TW)

(72) Inventors: FENG-JUNG HSU, ZHUBEI CITY (TW); TSUNG-HUA WU, ZHUBEI CITY (TW)

(21) Appl. No.: 17/109,673

(22) Filed: Dec. 2, 2020

Related U.S. Application Data
(60) Provisional application No. 62/942,669, filed on Dec. 2, 2019.

(51) Int. Cl. G01J 5/60; G01J 1/42

(52) U.S. Cl. CPC G01J 5/60; G01J 2005/608; G01J 1/4204

(57) ABSTRACT

An optical sensing method and an optical sensor module thereof. The optical sensing method includes obtaining an optical signal by sensing with a first optical sensor and a second optical sensor, respectively. The first optical sensor and the second optical sensor have different optical sensing wavelength ranges. Furthermore, a color temperature determination unit receives the optical signals of the first and second optical sensors and calculates a color temperature value by substituting an equation. In this way, the optical sensing method and its optical sensor module can obtain color temperature calculations with high accuracy and can effectively reduce the system computational complexity.

### FIELD OF THE INVENTION

The present invention refers to an optical sensing method and optical sensor module, in particular a method of sensing light temperature and respective module.

### BACKGROUND OF THE INVENTION

The optical sensors using the optical sensing technology are widely applied in many applications; for example, the ambient light sensor (ALS) can be used in electronic products to sense the intensity of ambient light, used to adjust the display brightness, improve the user convenience and extend battery operating time. Besides simply detecting ambient light intensity, optical sensors also can be used to sense the Correlated Color Temperature (CCT) of ambient light, used to adjust the backlight of display and display screen color or white balance parameter during photographing, etc.

In the existed technology, it sets three visible light bandpass filter photosensitive elements (for example: red light, green light and blue light) and calculate the color spatial coordinates (for example: corresponding to CIE 1931 XYZ system color coordinates) according to the signals sensed by the three photosensitive elements and further calculate CCT. Yet, referring to FIG. 1, which is the schematic diagram of light-penetrating ratio through an opaque cover (for example, the cellphone black glass cover. While practically applied in electronic products, if the optical sensor is equipped under the opaque cover, since the light-penetrating ratios of lights with different wavelengths are different, as shown in FIG. 1, normally, when the light with a wavelength close to red light or infrared light (such as light with wavelength more than 700 nm), the light-penetrating ratio through the opaque cover is high and would cause the CCT miss miscalculated the color temperature according to the sensing results of three photosensitive elements. Although it can correct the CCT value by using backend software according to the light-penetrating ratio through an opaque cover, yet, the optical sensor being corrected becomes not applicable under a transparent cover case.

Due to the fact that the optical sensor has very strict cost requirements, if a further improved optical sensing method and its optical sensor module could be provided, the optical sensor can accurately measure the CCT regardless of whether the optical sensor is placed under a transparent or an opaque cover and will greatly increase the market value of using an optical sensor to measure CCT.

### SUMMARY

The purpose of the present invention is to provide an optical sensing method and an optical sensor module, using only two sets of photosensitive elements to sense the ratio of optical signal value and calculate CCT. When the optical sensor module used in the present invention is equipped under an opaque cover, it can obtain the CCT with higher accuracy and effectively reduce the overall developing cost of products. On the other hand, the present invention has derived the polynomial equation between the ratio of the optical signal value of the two photosensitive elements and the CCT value of the colorimeter, making the optical sensor module can directly use the ratio to calculate the CCT value, which can effectively reduce the complexity of the system and simplify the circuit and its design cost.

The present invention refers to an optical sensing method, which uses a first photosensitive element and a second photosensitive element to sense about and obtains an optical signal value; the effective photosensitive wavelength ranges of the first photosensitive element and the second photosensitive element are different. Moreover, use a CCT judging unit to receive the optical signal values from the first photosensitive element and the second photosensitive element and substitute them into an equation to calculate a CCT value.

The present invention refers to an optical sensor module, which includes an optical sensor and a CCT judging unit. The optical sensor includes a first photosensitive element and a second photosensitive element; the first photosensitive element and the second photosensitive element are sensed to obtain an optical signal value; the effective photosensitive wavelength ranges of the first photosensitive element and the second photosensitive element are different. The CCT judging unit is coupled to the first photosensitive element and the second photosensitive element to receive the optical signal values from the first photosensitive element and the second photosensitive element and substitute them into an equation to calculate a CCT value.

### BRIEF DESCRIPTION OF THE DRAWINGS

FIG. 1: The schematic diagram of light-penetrating ratio through an opaque cover;

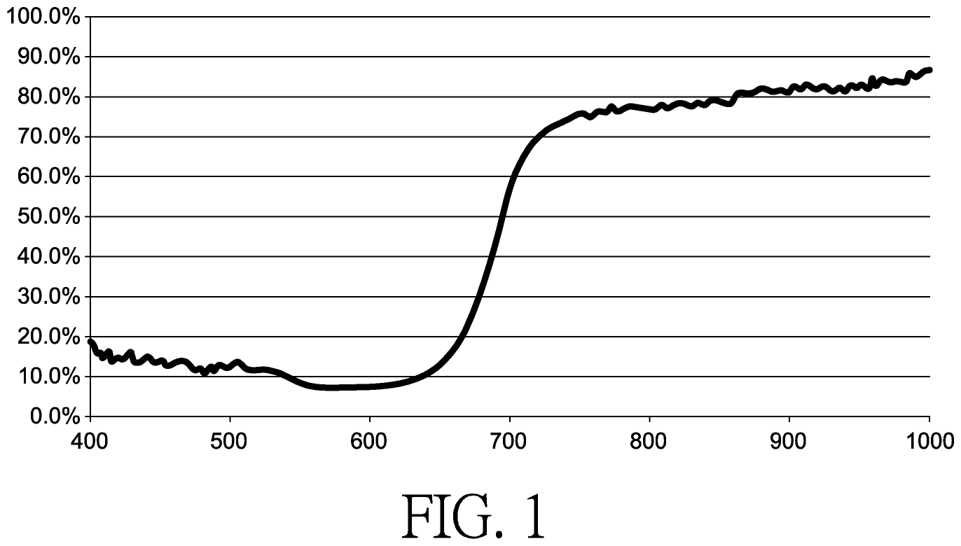

FIG. 2: The schematic diagram of optical sensor module configuration used in an embodiment of optical sensing method in the present invention;

FIG. 3: The associated schematic diagram of photosensitive wavelength ranges for the first photosensitive element and the second photosensitive element and light-penetrating ratio through an opaque cover;

FIG. 4: The schematic diagram of equation generating flow in an embodiment of optical sensing method in the present invention;

FIG. 5: The schematic diagram of optical sensor module configuration used in the other embodiment of optical sensing method in the present invention;

### DETAILED DESCRIPTION

We've used some terms in the invention description and claims to specify certain devices; yet, anyone in the field of the present invention with common knowledge shall be able to understand these terms; manufacturers might use different terms to call the same device, and the present invention description and claims don't use the name variety as the criterion of distinction, insteads, the present invention description and claims use the difference in overall technology as the criterion. the “include” mentioned in the entire invention description and claims is an open term, which shall be explained as “include but not limited to”. moreover, the “couple with” herein includes the direct and indirect methods. therefore, if in there is an expression of “a primary device is coupled to the secondary device”, it means that the primary device is coupled to the secondary device directly or via other device or connecting way that is coupled to the secondary device indirectly.

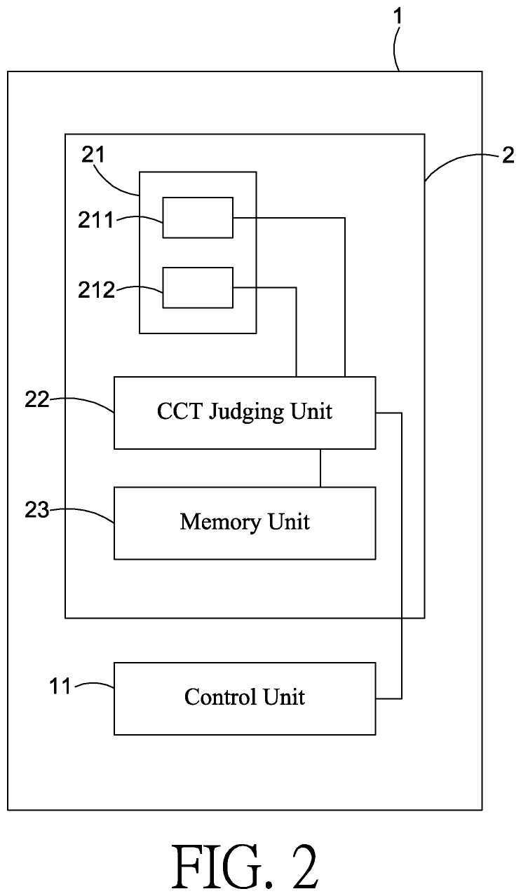

Refer to FIG. 2; to facilitate the explanation of optical sensing embodiment in the present invention, an electronic device 1 is taken for example; this electronic device 1 can equip an optical sensor module 2. the optical sensor module 2 includes an optical sensor 21 and a CCT judging unit 22; the optical sensor 21 includes a first photosensitive element 211 and a second photosensitive element 212; the first photosensitive element 211 and the second photosensitive element 212 are both coupled to the CCT judging unit 22 to transmit the sensing signals to the CCT Judging Unit 22 respectively.

The First photosensitive element 211 and the second photosensitive element 212 can include the photodiode or other photo sensing structure; the photosensitive wavelength ranges of the first photosensitive element 211 and the second photosensitive element 212 are different. In detail, it can be the bandpass filter photosensitive element by using the first photosensitive element 211 and the second photosensitive element 212 plus different light-filtering coatings; or using the bandpass filter circuit to filter the sensing signals of the first photosensitive element 211 and the second photosensitive element 212, making it become the bandpass filter photosensitive element. The effective photosensitive wavelength ranges of first photosensitive element 211 and second photosensitive element 212 are different, which can be within 300 nm˜600 nm and 400 nm˜700 nm respectively, the preferable ones are, within 320 nm 580 nm and 420 nm˜680 nm; the most preferable ones are within 340 nm 560 nm and 440 nm˜660 nm.

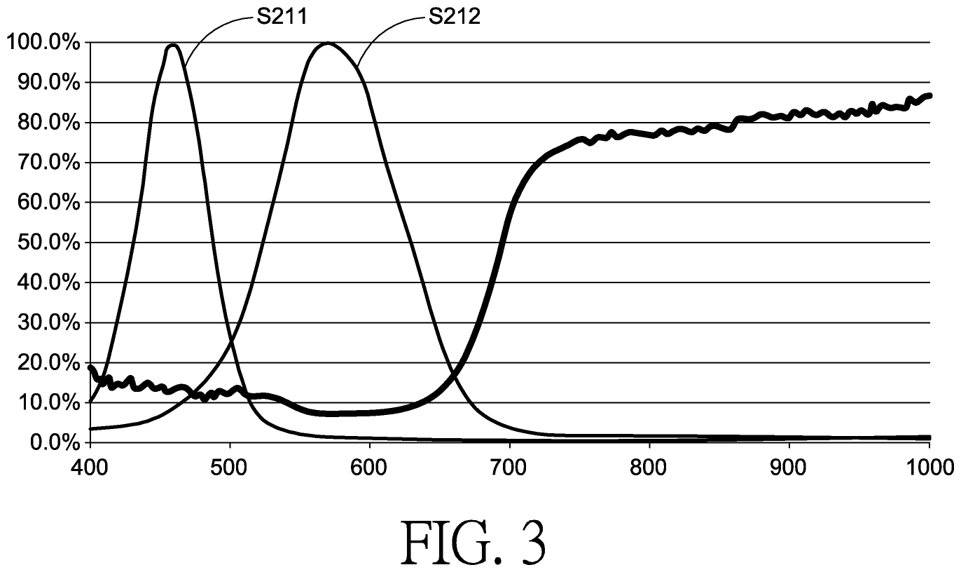

Refer to FIG. 3, which is the associated schematic diagram of photosensitive wavelength ranges S211 and S212 for the first photosensitive element and the second photosensitive element and the light-penetrating ratio through an opaque cover. In this embodiment of the present invention, the first photosensitive element 211 can pick a blue light photosensitive element, for example, the maximum sensed wavelength can select 460 nm; in contrast, the second photosensitive element 212 can pick a green light photosensitive element that select 570 nm as a maximum sensed wavelength. Therefore, the first photosensitive element 211 and the second photosensitive element 212 can effectively sense light within the respective two photosensitive wavelength ranges (340 nm 560 nm and 440 nm˜660 nm. As said above, when wavelength of the light is closer to red light or IR, (for example, light with wavelength higher than 700 nm), the ratio of penetrating the opaque cover is higher; yet, as shown in FIG. 3, since light in this wavelength range is hardly sensed by first photosensitive element 211 and second photosensitive element 212, the embodiment of optical sensing method in the present invention can be performed effectively.

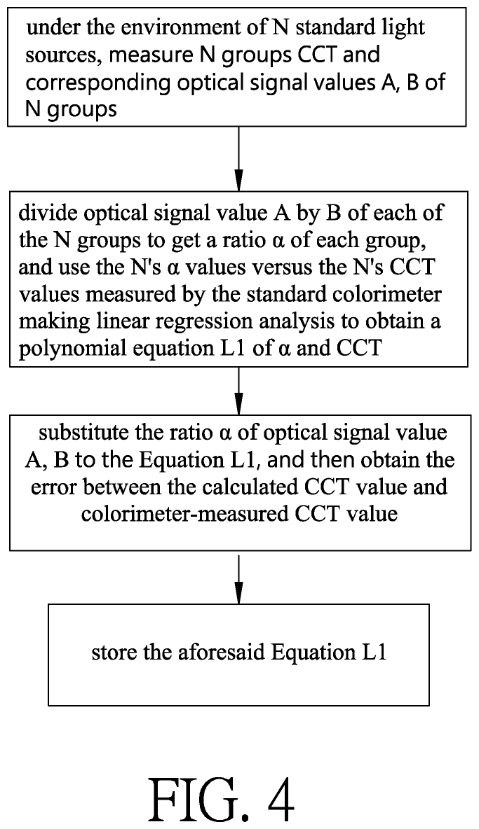

In details, refer to FIG. 4, which is the schematic diagram of equation generating flow in an embodiment of optical sensing method in the present invention. First, under the environment of N standard light sources, the CCT can be measured by using a standard colorimeter. Meanwhile, it also can measure the optical signal values A, B of N groups by using the first photosensitive element 211 and second photosensitive element 212 of the optical sensor module 2, in which a is the optical signal value sensed by the first photosensitive element 211 and B is the optical signal value sensed by the second photosensitive element 212. Next, divide optical signal value A by B of each of the N groups to get a ratio α of each group, and use the N's a values versus the N's CCT values measured by the standard colorimeter making linear regression analysis to obtain a polynomial equation L1 of α and CCT. The standard light source can be the incandescent light “A”, horizontal daylight “HZ”, simulated daylight “D50 or D65” or various fluorescence “CWF, U30, U35, TL83 or TL84” to provide a variety of different CCT environmental conditions.

From this, after the optical sensing method in the embodiment of the present invention has applied the above step to generate Equation L1, it can use the ratio α of optical signal value A, B sensed by the first photosensitive element 211 and the second photosensitive element 212 to calculate CCT. The judging coefficient made while generating Equation L1 can judge the accuracy of Equation L1; yet, in this embodiment, it can further substitute N's ratios α to Equation L1 to obtain the error between the calculated CCT value and colorimeter-measured CCT value, and certify whether Equation L1 has satisfied the demanding or not? The aforesaid ratio α values, colorimeter-measured CCT values, calculated CCT values and respective errors are listed in Table 1 below.

TABLE 1

| | Colorimeter | Calculated | |
|---|---|---|---|
| α*100 | CCT | CCT | Error |
| 52 | 6480 | 6027 | −7% |
| 30 | 4204 | 3905 | −7% |
| 29 | 4066 | 3826 | −6% |
| 29 | 3999 | 3850 | −4% |
| 29 | 3990 | 3812 | −4% |
| 28 | 3995 | 3761 | −6% |
| 29 | 4127 | 3866 | −6% |
| 29 | 3997 | 3860 | −3% |
| 29 | 3926 | 3858 | −2% |
| 28 | 3837 | 3769 | −2% |
| 42 | 4787 | 5039 | 5% |
| 23 | 3145 | 3205 | 2% |
| 21 | 2895 | 3045 | 5% |
| 20 | 2805 | 2944 | 5% |
| 20 | 2784 | 2917 | 5% |
| 19 | 2762 | 2839 | 3% |
| . | . | . | . |
| . | . | . | . |
| . | . | . | . |

After the optical sensing method embodiment of the present invention uses the aforesaid steps to generate Equation L1, it can write the Equation L1 into the CCT judging unit 22 of the optical sensor module 2. That is, when applying optical sensor module 2 in the electronic device 1, after both the first photosensitive element 211 and the second photosensitive element 212 transmit the sensing signals to the CCT judging unit 22, it can calculate CCT according to Equation L1. The CCT judging unit 22 can be coupled to a control unit 11 of the electronic device 1, and the control unit 11 can use the calculated CCT value to make an adjustment to the display backlight, screen color or photo-taking white balance of the electronic device 1. It is notable that in some embodiments of the present invention, the CCT judging unit 22 also can be replaced by the calculating circuit equipped in electronic device 1. In other words, the optical sensor module 2 can only perform optical sensing, and transmits the sensing signal to the electronic device 1 for subsequent calculations, without affecting the implementation of the optical sensing method embodiment in the present invention.

Actually, in response to different process conditions, component specifications or usage requirements, it may be necessary to form multiple sets of equations stored in the optical sensor module 2, and then select appropriate equations according to the actual circumstance. Therefore, in the embodiment of the present invention, the optical sensor module 2 can also be provided with a memory unit 23, the memory unit 23 includes a non-volatile memory for storing the aforesaid equation l1, and the memory unit 23 is coupled to the CCT judging unit 22 and can select appropriate equations in the memory unit 23 to calculate the CCT value.

In summary, the optical sensing method embodiment of the present invention and the optical sensor module only use the ratio of the optical signal values sensed by the two sets of photosensitive elements to calculate the CCT value. Compared with the existed art that base on the fact that the CCT values are calculated from the signals sensed by three sets of photosensitive elements, when the optical sensor module used in the embodiment of the present invention is placed under an opaque cover, a CCT calculation value with higher accuracy can be obtained. In other words, the optical sensing method in the embodiment of the present invention is suitable for placing the optical sensor module under an opaque cover or a transparent cover, which can effectively reduce the overall product R&D cost. Furthermore, the embodiment of the present invention derives the polynomial equation between the ratio of the optical signal values of the two photosensitive elements and the colorimeter CCT value, so that the optical sensor module can directly use the ratio to calculate the CCT value; as compared with the existed art, the CCT value needs to be further derived by calculating the color space coordinates based on the signals sensed by the three sets of photosensitive elements; therefore, the embodiment of the present invention can effectively reduce the complexity of the system operation, and thereby simplify the circuit and its design cost.

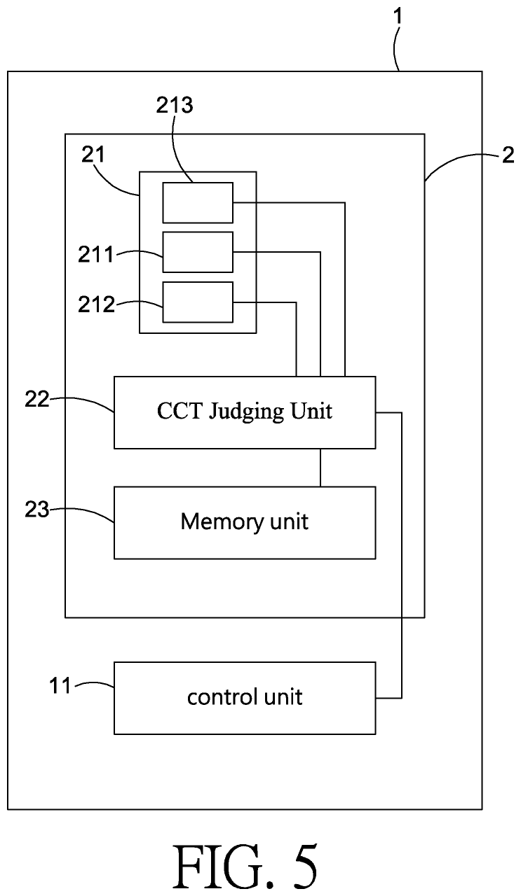

In order to further reduce the error of the calculated CCT value, the optical sensing method in the other embodiment of the present invention, the standard light source environment can be grouped and the corresponding polynomial equations can be generated respectively, referring to FIG. 5 for details. The optical sensor 21 of the optical sensor module 2 used in this embodiment further includes a third photosensitive element 213. The third photosensitive element 213 can be an infrared photosensitive element or a wide domain full spectrum photosensitive element, and its photosensitive range preferably includes the 700 nm˜1100 nm light band. The third photosensitive element 213 is also coupled to the CCT judging unit 22 to transmit sensing signals to the CCT judging unit 22.

In this way, the optical signal value C sensed by the third photosensitive element 213 can be used to evaluate the ratio of light components with wavelengths close to red or infrared in a standard light source environment. Accordingly, another embodiment of the optical sensing method of the present invention can use the optical signal value C to group standard light source environments. For example, the ratio β of the optical signal value C and the optical signal value A sensed by the first photosensitive element 211 is used to group the standard light source environments. If the ratio β is higher than 10 as a judging criterion, the measurement result of aforesaid N groups of standard light source environments can be divided into two groups, listed in Table 2 and Table 3 below.

TABLE 2
(Ratio β < 10)

| | | Colorimeter | Calculated | |
|---|---|---|---|---|
| β | α*100 | CCT | CCT | Error |
| 6 | 57 | 6480 | 6506 | 0% |
| 3 | 31 | 4203 | 4047 | −4% |
| 3 | 31 | 4066 | 4055 | 0% |
| 3 | 30 | 3999 | 3956 | −1% |
| 3 | 30 | 3984 | 3912 | −2% |
| 3 | 30 | 3995 | 3871 | −3% |
| 3 | 30 | 4124 | 3950 | −4% |
| 3 | 30 | 3996 | 3945 | −1% |
| 3 | 30 | 3911 | 3873 | −1% |
| 3 | 29 | 3837 | 3802 | −1% |
| 6 | 57 | 6480 | 6506 | 0% |
| . | . | . | . | . |
| . | . | . | . | . |
| . | . | . | . | . |

Wherein, using the standard light source environment sensing result with the ratio β lower than 10, the ratio α and the CCT value measured by the standard colorimeter are subjected to a regression analysis to obtain a polynomial equation with the variants of the ratio α(x) and the CCT value (y) A; an example of which is shown in the following Equation (1):

y=9535.3x+1055.8 (1)

TABLE 3
(Ratio β > 10)

| | | Colorimeter | Calculated | |
|---|---|---|---|---|
| β | α*100 | CCT | CCT | Error |
| 15 | 25 | 2865 | 2675 | −7% |
| 21 | 25 | 2319 | 2676 | 15% |
| 13 | 39 | 2865 | 2525 | −12% |
| 15 | 45 | 2321 | 2454 | 6% |
| 15 | 28 | 2865 | 2645 | −8% |
| 19 | 29 | 2325 | 2629 | 13% |
| 15 | 28 | 2865 | 2642 | −8% |
| 19 | 30 | 2323 | 2626 | 13% |
| 17 | 33 | 2865 | 2590 | −10% |
| 20 | 37 | 2320 | 2545 | 10% |
| 12 | 34 | 2866 | 2577 | −10% |
| 15 | 38 | 2321 | 2538 | 9% |
| . | . | . | . | . |
| . | . | . | . | . |
| . | . | . | . | . |

Using the standard light source environment sensing result with the ratio β greater than 10, the ratio α and the CCT value measured by the standard colorimeter are subjected to a regression analysis to obtain a polynomial equation with the variants of the ratio α(x) and the CCT value (y) A; an example of which is shown in the following Equation (2):

y=−1091x+2948.8 (2)

Although in the aforesaid embodiment, the second photosensitive element 212 is selected as a green photosensitive element for sensing light within the photosensitive wavelength range of 440 nm to 660 nm, the second photosensitive element 212 can still sense trace amounts of red light, so when the light component with the wavelength close to red light or infrared light is more, it may still affect the relationship between the ratio α of the optical signal values A and B sensed by the first photosensitive element 211 and the second photosensitive element 212 and the CCT. Another embodiment of the optical sensing method in the present invention uses the optical signal value C sensed by the third photosensitive element 213 to group the standard light source environments, and calculate the corresponding polynomial equation (1) and (2) in different standard light source environment groups, stored in the memory unit 23, and the CCT judging unit 22 can select the appropriate equation in the memory unit 23 to calculate the CCT value according to the respective circumstance, which will obtain a more accurate CCT calculating value.

In summary, the present invention provides an optical sensing method and an optical sensor module, which only uses the ratio of the optical signal values sensed by two sets of photosensitive elements to calculate the CCT value, so that when the optical sensor module of the embodiment in the present invention is placed under the opaque cover, a more accurate CCT calculating value can be obtained, which effectively reduces the overall product R&D cost. On the other hand, the embodiment of the present invention derives the polynomial equation between the ratio of the optical signal value of the two photosensitive elements and the colorimeter CCT value, so that the optical sensor module can directly use the ratio to calculate the CCT value, which can effectively reduce the computing complexity of the system and simplify the circuit and its design cost. In addition, in some embodiment of the present invention, the optical signal values of another set of photosensitive elements can be additionally used to group the standard light source environments. Although the optical signal value of the other set of photosensitive element is not used to calculate the CCT value, it can be used to evaluate the ratio of light components in a specific wavelength band (for example, the wavelength is close to red or infrared light) of the standard light source environment to further reduce the error of the CCT calculating value produced thereof

What is claimed is:

1. An optical sensing method, including:
using a first photosensitive element and a second photosensitive element to sense and obtain an optical signal value, and in which the effective photosensitive wavelength ranges of the first photosensitive element and the second photosensitive element are different; and
using a CCT judging unit to receive the optical signal values of the first photosensitive element and the second photosensitive element, and substitute the optical signal values into an equation to calculate a CCT value.

2. The optical sensing method of claim 1, wherein the CCT judging unit lets the optical signal value of the first photosensitive element divide the optical signal value of the second photosensitive element to obtain a ratio, and substitute the ratio into the equation to calculate and obtain a CCT value.

3. The optical sensing method of claim 2, further comprising under several standard light source environments, using a standard colorimeter to measure several CCT values, and using the first photosensitive element and the second photosensitive element to measure and obtain the several optical signal values; next, make dividing operation among the different optical signal values to obtain respective ratios, and using the ratios and the CCT values measured by the standard colorimeter to make analytic operation to obtain the equation of the ratio and CCT value.

4. The optical sensing method of claim 3, wherein the analytic operation is a linear regression analysis; the equation is a polynomial equation.

5. The optical sensing method of claim 3, further comprising an optical signal value sensed by a third photosensitive element, using the optical signal value of third photosensitive element to group the standard light source environments and calculate the corresponded equation within different standard light source groups.

6. The optical sensing method of claim 5, wherein the third photosensitive element is an infrared photosensitive element, or the photosensitive range of the third photosensitive element includes the 700 nm˜1100 nm light band.

7. The optical sensing method of claim 6, wherein the grouping includes the way of using the judging criterion of if the ratio of the optical signal value sensed by the third photosensitive element and the optical signal value sensed by the first photosensitive element is larger than a threshold or not.

8. The optical sensing method of claim 1, wherein the effective photosensitive wavelength range of the first photosensitive element is within 300 nm˜600 nm, and the effective photosensitive wavelength range of the second photosensitive element is within 400 nm˜700 nm.

9. The optical sensing method of claim 8, wherein the effective photosensitive wavelength range of the first photosensitive element is within 340 nm 560 nm, and the effective photosensitive wavelength range of the second photosensitive element is within 440 nm˜660 nm.

10. An optical sensor module, which includes:
an optical sensor, including a first photosensitive element and a second photosensitive element; the first photosensitive element and the second photosensitive element are used to sense an optical signal value, the effective photosensitive wavelength ranges of the first photosensitive element and the second photosensitive element are different; and
a CCT judging unit, coupled to the first photosensitive element and the second photosensitive element to receive the optical signal values from the first photosensitive element and the second photosensitive element, and substitute them to an equation to calculate a CCT value.

11. The optical sensor module of claim 10, wherein the CCT judging unit divides the optical signal value of the first photosensitive element to the optical signal value of the second photosensitive element to obtain a ratio, and substitute the ratio to the equation to obtain the CCT value.

12. The optical sensor module of claim 11, in which the equation is a polynomial equation of the ratio and the CCT value.

13. The optical sensor module of claim 10, wherein the optical sensor another includes an optical signal value sensed by a third photosensitive element; use the third photosensitive element to sense and obtain an optical signal value; the CCT judging unit is coupled to a third photosensitive element to receive the optical signal value of the third photosensitive element.

14. the optical sensor module of claim 13, wherein the third photosensitive element is an infrared photosensitive element, or the photosensitive range of the third photosensitive element includes the 700 nm˜1100 nm light band.

15. The optical sensor module of claim 13, further comprising a memory unit that stores several polynomial equations; the memory unit is coupled to the CCT Judging Unit, the CCT judging unit follows the optical signal value of the third photosensitive element and uses a polynomial equation selected by the memory unit as the equation.

16. The optical sensor module of claim 10, wherein the effective photosensitive wavelength range of the first photosensitive element is within 300 nm˜600 nm; the effective photosensitive wavelength range of the second photosensitive element is within 400 nm˜700 nm.

17. The optical sensor module of claim 16, wherein the effective photosensitive wavelength range of the first photosensitive element is within 340 nm 560 nm; the effective photosensitive wavelength range of the second photosensitive element is within 440 nm˜660 nm.
